(19) United States
(12) Patent Application Publication
(10) Pub. No.: US 2011/0158203 A1
(43) Pub. Date: Jun. 30, 2011

(54) PROPORTIONAL FAIR SCHEDULING WITH PACKET TRANSMISSION

(75) Inventor: Erez BITON, Herzlia (IL)

(73) Assignee: Alvarion Ltd., Tel-Aviv (IL)

(21) Appl. No.: 12/650,632

(22) Filed: Dec. 31, 2009

(51) Int. Cl. H04W 72/12

(52) U.S. Cl. 370/336; 370/329

(57) ABSTRACT

A scheduler for transmission of Packetized data over a transmission link between a base station device and various terminal devices, each packet being associated with one terminal device, and the packets being of variable length. The scheduler calculates for each terminal device a proportional fair allocation metric, assigns a next available channel transmission resource to a device having a best metric, but only actually sends a next packet to a respective terminal device provided that respectively allocated and as yet unused channel transmission resources are sufficient to accommodate the next packet. Thus the packets are sent unfragmented and based on a proportional fair resource allocation.

### FIELD AND BACKGROUND OF THE INVENTION

The present invention, in some embodiments thereof, relates to proportionally fair scheduling for packet transmission and, more particularly, but not exclusively, to such a scheme for wireless communications.

Base stations generally deal with multiple mobile stations MS, some of which require larger bandwidths than others, some of which have better connections than others, and some of which have greater capabilities than others. In ideal circumstances the base station has plenty of resources and each MS gets all the attention it needs. However often resources are stretched, and even if the resources are not stretched the base station needs some way of fairly allocation its attention between the MSs. Thus, scheduling algorithms, for example in WiMax, are a key factor in the performance of the network base station. There are many scheduling schemes for different data transmission systems, for example the Proportional Fair scheduling scheme (PF) has been designed for 3G CDMA systems, where one user at a time is selected for transmission on the available resources. With respect to Round-Robin (RR) scheduling, where users are cyclically scheduled irrespective of the channel condition, this increases the system throughput while maintaining the long-term allocation fairness between users. The PF scheduler allocates the user i* who maximizes the ratio of achievable instantaneous data-rate over average received data-rate, as follows:

$${P}_{i} ( k ) = \frac{{R}_{i} ( k )}{{[ {T}_{i} ( k ) ]}^{α}}$$

$${i}^{*} = {arg}_{i} max \{ {P}_{i} ( k ) \} ,$$

where
k is the slot index,
Rᵢ(k) is the data rate potentially achievable for the i-th mobile station based upon the reported C/I and the power available,
Tᵢ(k) is the average “fairness throughput” of the i-th mobile station up to time k, and
α is the fairness exponent factor.
   The average “fairness throughput” can be calculation as follows:

$${T}_{i} ( k ) = \{ \begin{matrix}β {T}_{i} ( k - 1 ) & if the i \text{-} th MS wan not scheduled at time k - 1 \\ \begin{matrix}β {T}_{i} ( k - 1 ) + \\ ( 1 - β ) {N}_{i} ( k - 1 )\end{matrix} & if the i \text{-} th MS was scheduled at time k - 1 ,\end{matrix}$$

where
β denotes the response time of the low-pass filter and
Nᵢ(k−1) is the number of bits delivered to the MS at slot k−1.
   The PF is known for the following optimality property:
   Under the proportional fair algorithm, the long-term average throughput of each user exists and is retained, and the algorithm maximizes

$${\sum }_{k = 1}^{K} log {T}_{k}$$

effectively for most cases among the class of all schedulers.

A Generalized Proportional Fair (GPF) approach that applies to OFDMA where the scheduling is performed in time domain and frequency domain has been proposed by Christian Wengerter et al. Fairness and Throughput Analysis for Generalized Proportional Fair Frequency Scheduling in OFDMA, Vehicular Technology Conference 2005, the contents of which are hereby incorporated by reference. In this citation, the GPF approach allocates units in a 2-dimensional time-frequency grid according to the above metric.

Proportionally fair schemes of the kind described above tend to segment individual packets. However a segmented packet is not treated as received until the entire packet is received. If there are X packets to be distributed between X devices in a given time frame then the transmission will be distributed in a way that is proportionally fair but each device may receive all the fragments of its packet towards the end of the time frame, so that the average transmission time actually tends towards the worst transmission times rather than towards the average.

Cross-Layer proportional fair scheduling by Jinri Huang (IEICE Trans. Commun. Vol E91-B 6 Jun. 2008) proposes proportional fair scheduling using a packet length constraint. Packet length is taken as a parameter requiring optimization in a proportional fair metric. In the scheme described, sub-carriers are assigned to different connections, and then the scheme checks whether individual connections are satisfied as far as packet length is concerned. Surplus subcarriers from satisfied users are then reallocated amongst the unsatisfied users. The user with the least stringent packet length constraint is satisfied first.

The proposal has difficulties with implementation and involves high and unnecessary computational complexity.

### SUMMARY OF THE INVENTION

The present invention, in some embodiments thereof relates to a scheduling scheme in which a transmission time frame is set up to allow transmission “slots”, wherein each “slot” fits a whole packet. Thus complete packets are transmitted in single slots as complete units, and the overall transmission time once again tends towards the average.

According to an aspect of some embodiments of the present invention there is provided a scheduling method for transmission of packetized data over a transmission link between a base station and various terminal devices, said packetized data comprising a plurality of data packets, each packet being associated with one of said terminal devices, said packets being of variable length, the method comprising:
calculating for each terminal device a proportional fair allocation metric;
assigning a next available channel transmission resource to a device having a best metric; and
sending a next packet to a respective terminal device when respectively allocated and as yet unused channel transmission resources are sufficient to accommodate said next packet.

In an embodiment, said next available transmission resource is a fixed time slot.

In an embodiment, said sending a next packet to a respective terminal device when respectively allocated and as yet unused channel transmission resources are sufficient to accommodate said next packet, comprises sending said next packet when correspondingly allocated fixed time slots are sufficient for a respective length of said next packet.

In an embodiment, said proportional fair metric allocates said resources to said respective terminal devices in a manner emulative of a proportional fair allocation scheme for allocating fixed time slots between said devices.

In an embodiment, said sending to said resources comprises sending respective packets such that an end time for transmission of a given packet is at least as early as the transmission time of a last slot of the given packet had it been split between said fixed time slots of said proportional fair allocation scheme, said transmission time of said last slot being obtained by simulating said proportional fair allocation scheme.

In an embodiment, said proportional fair allocation metric takes account of a size of a respective packet.

In an embodiment, said assigning to a device having a best metric comprises assigning a resource to maximize i*; wherein:

$${i}^{*} = {arg}_{i} max \{ {P}_{i} \}$$

$$where$$

$${P}_{i} = \frac{{R}_{i}}{{[ {T}_{i} ]}^{α}}$$

Rᵢ is the data rate potentially achievable for the i-th mobile station based upon the reported C/I and the power available (MCSᵢ),
Tᵢ is the average fairness throughput of the i-th terminal before scheduling decision,
Tᵢ′ is the average fairness throughput of the i-th terminal after the scheduling decision, and
α is the fairness exponent factor.

In an embodiment, Ti and Ti′ are obtained as follows:

$${T}_{i} = \{ \begin{matrix}β {T}_{i} & if the HOL packet of the i \text{-} th MS was not scheduled \\ \begin{matrix}β {T}_{i} + \\ ( 1 - β ) {N}_{i}\end{matrix} & if the HOL packet of the i \text{-} th MS was scheduled\end{matrix} \\ and \\ {T}_{i}^{′} = β {T}_{i} + ( 1 - β ) {N}_{i}$$

In an embodiment, said emulation comprises maximizing

$${\sum }_{k = 1}^{K} log {T}_{k}$$

Where k is the packet index and Tₖ is the average fairness throughput of the ith mobile station up to slot k.

In an embodiment, said transmission link is a WiMax link.

According to a second aspect of the present invention there is provided apparatus for allocating packets for transmission over a link between a base station and a plurality of terminal devices, respective packets being of variable length and link resources being shared between connections of said base station and respective terminal devices; the apparatus comprising:

a virtual fixed resource proportional fair scheduler operative to assign fixed link resources between respective connections based on a proportional fair metric; and

a packetized proportional fair scheduler configured to send a next packet over a given connection when said given connection has accrued sufficient of said fixed link resources to accommodate a size of said respective packet.

In an embodiment, said fixed link resources comprise fixed time slots.

An embodiment may comprise a buffer for storing packets until respective given connections have accrued said sufficient fixed link resources.

According to a third aspect of the present invention there is provided a system comprising a base station and a plurality of terminal devices and an allocation unit for allocating packets for transmission over links between said base station and respective ones of said terminal devices, respective packets being of variable length and link resources being shared between said links; the allocation unit comprising:

a virtual fixed resource proportional fair scheduler operative to assign fixed link resources between respective links based on a proportional fair metric; and

a packetized proportional fair scheduler configured to send a next packet over a given link when said given link has accrued sufficient of said fixed link resources to accommodate a size of said respective packet.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided for programming if needed. The network may be a wireless network including a cellular network and may include CDMA, GSM, LTE, UMTS, OFDMA amongst others.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram showing allocation using a time frequency grid according to the prior art;

FIG. 2 is a simplified schematic diagram showing a base station serving multiple mobile stations;

FIG. 3 is a simplified schematic diagram showing a scheduler according to a first embodiment of the present invention; and

FIG. 4 is a simplified flow chart showing operation of the scheduler of FIG. 3.

### DESCRIPTION OF EMBODIMENTS OF THE INVENTION

The present embodiments relate to proportionally fair scheduling for packet transmission and, more particularly, but not exclusively, to such a scheme for radio links in wireless communications such as WiMax.

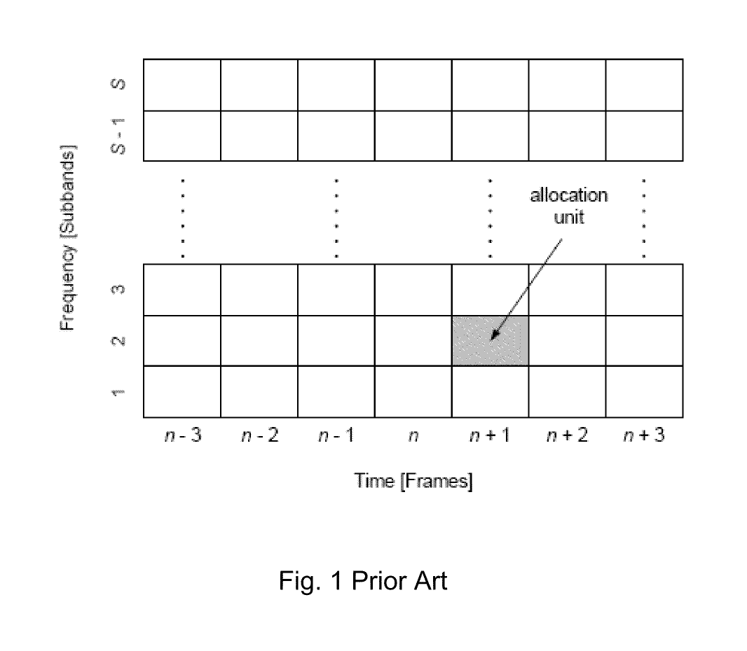

In general packets are of variable length. Existing proportional fair scheduling schemes, as per FIG. 1, are based on units of fixed length, which can simply be fitted into fixed time slots within a frame. The slots within a frame are then allocated in proportional fair manner between the different mobile stations. However if it is desired to send whole packets as indivisible units then the scheduling scheme cannot use the fixed size slots directly. Rather multiple slots from several frames are allocated according to the size of the packet. The effect is that individual packets may take up several frames and become fragmented. When a packet is fragmented, use of the packet at the receiving device is disrupted since none of the packet can be used until all of the packet has arrived. Also the link has a certain proportion of interference and loss of transmission. If one fragment of a packet is lost then in general the whole packet is lost.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

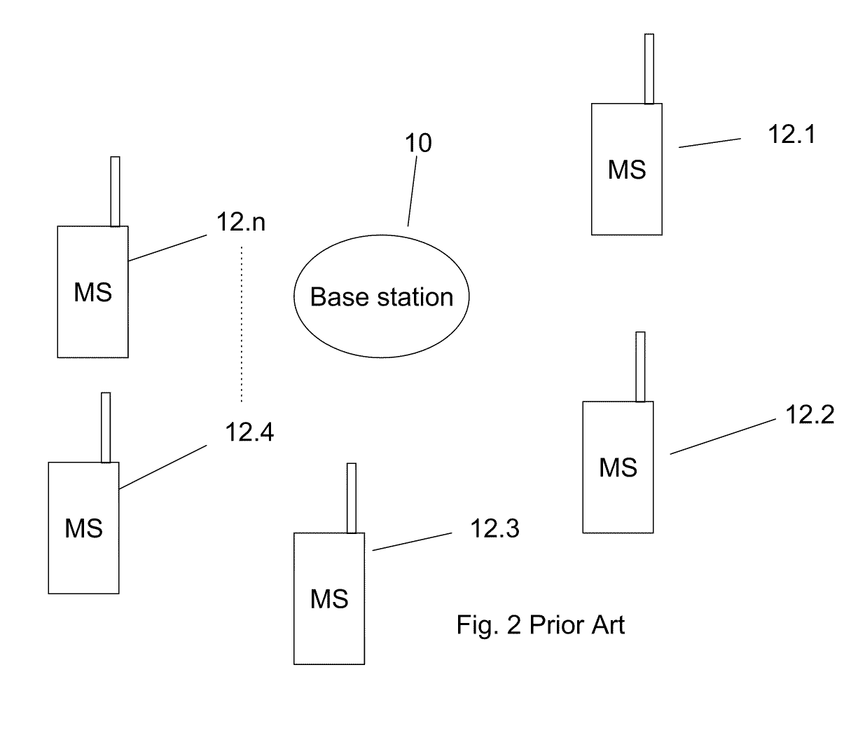

Referring now to the drawings, FIG. 2 illustrates a base station 10 surrounded by multiple mobile stations MS 12. The mobile stations may include portable computers, hand-held computing devices, mobile telephones or any other communication enabled device that happens to be in the vicinity of the base station. The base station communicates with each of the mobile stations and transmission is two way, base station to mobile station and mobile station to base station. Transmission uses data packets whose length is determined by the media type, the transmission protocol and numerous other factors. The base station tries to service each of the mobile stations in range so that each mobile station has an opportunity to transmit and to receive data.

As discussed above, the prior art scheduling for such a base station system uses time slots of fixed length. The time slots in the prior art are generally too small for the packets so that packets have to be transmitted in fractions. As mentioned, the receiving device can only use a packet once the entire packet has been received, so that the effective time of receipt is the actual time of receipt of the last fraction of the packet. Thus the scheduling scheme in practice has the effect of ensuring that if a group of packets are sent to a group of devices, each device experiences a delay in receiving the packet which is equivalent to the delay there would have been had the packet been transmitted as a whole but scheduled last in the queue.

On the other hand, simply making the time slots larger does not solve the problem since different packets are of different length. Even if variable length time slots are chosen, any fairness calculation used in scheduling the time slots would have to take into account the lengths of the time slots in order to fairly assign resources, otherwise a device currently receiving a small number of large packets would obtain unfair preference over a device receiving a large number of small packets.

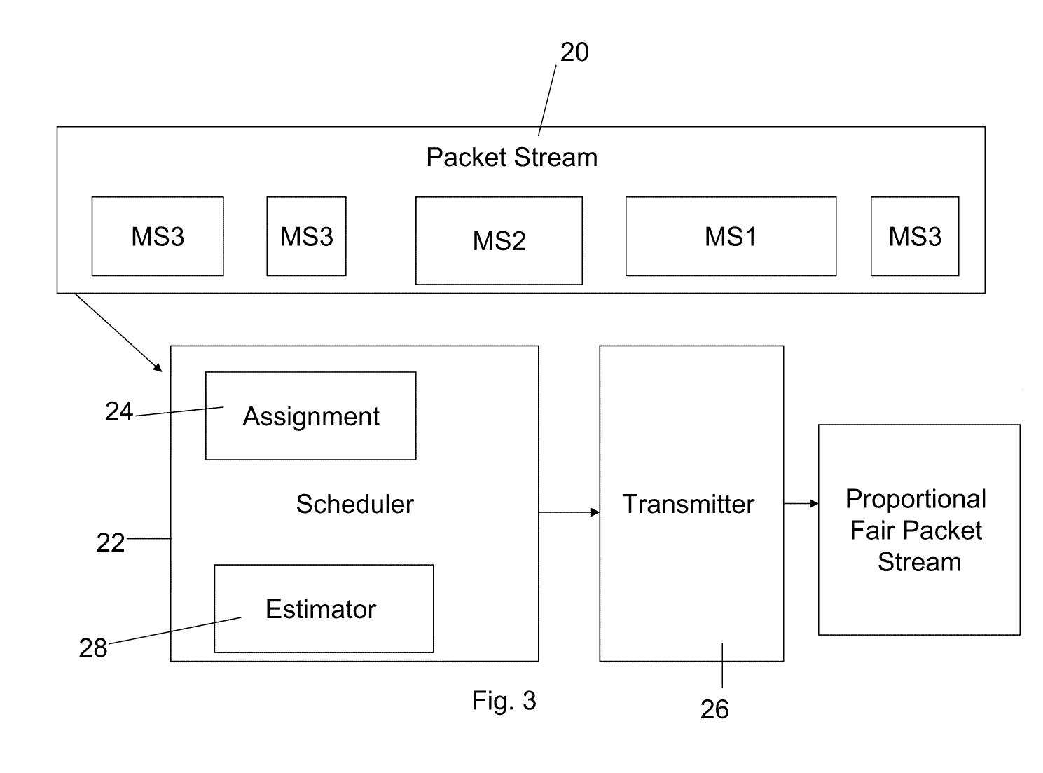

Reference is now made to FIG. 3, which illustrates a sequence of packets to be transmitted by the base station 10 to the mobile stations 12. Each packet is addressed to a particular mobile station. A scheduler 22 comprises a variable length packet assignment unit 24 to schedule packets over a transmission interval in a packet by packet scheduling scheme, as will be described hereinbelow.

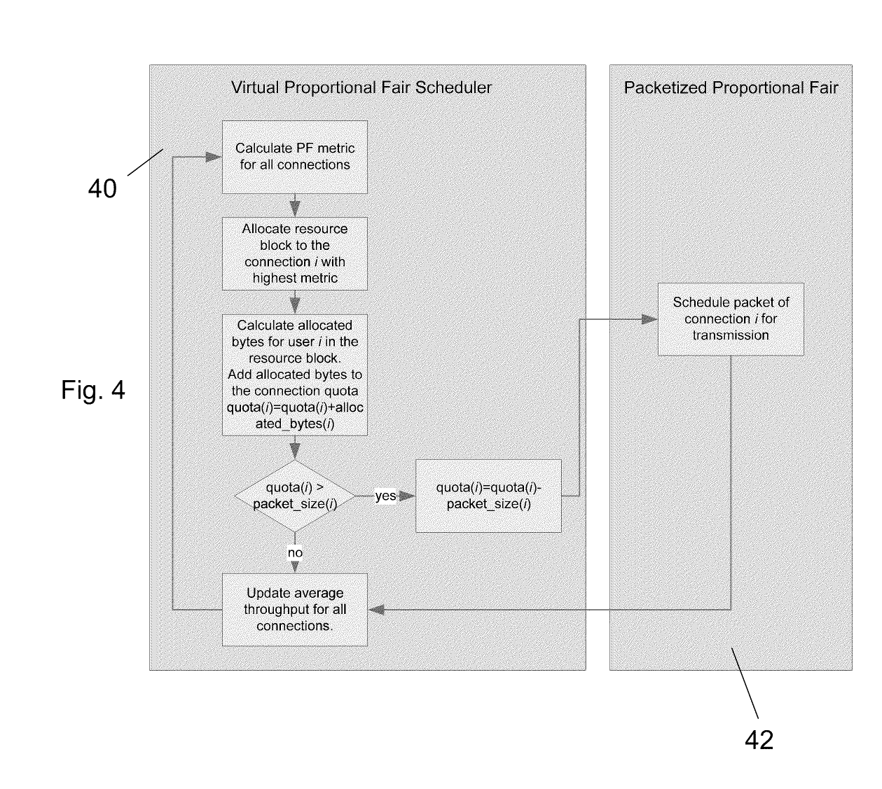

Reference is now made to FIG. 4 which illustrates the operation of a proportional fair packet scheduler according to an embodiment of the present invention.

FIG. 4 illustrates apparatus for allocating packets for transmission over a link such as shown in FIG. 3. The link is between a base station and various mobile stations or like terminal devices. The packets are of variable length. The link resources are shared between the various connections.

The sharing of the link resources is carried out by using a virtual proportional fair scheduler 40 and a packetized proportional fair scheduler 42. The virtual proportional fair scheduler assigns for example fixed transmission resources, typically time slots, on a proportional fair basis between the different connections. A PF metric is calculated for each of the connections. The time slots are then allocated to the connection currently having the highest metric. The time allocated for the link may then be translated into a number of bytes that can be transmitted, and the newly allocated bytes are added to any existing number of unallocated bytes. However the allocation does not relate to actual packets and their sizes. The allocation is virtual and the connections simply accumulate time slots or bytes or like transmission resources.

The accumulated time slots may be stored in a buffer. According to some embodiments of the present invention, if a quota(i) of user i is bigger than a packet_size(i) (as shown in FIG. 4) then the packet of user i is inserted to a buffer and later scheduled (e.g. in a FIFO order) for transmission.

It should be noted that if the buffer is full the process in the virtual scheduler is stopped till space is available at the buffer.

According to another embodiment of the present invention the packets in the buffer may be reordered, for example according to known metrics or mathematical methods know in the art, for reducing overheads and improving throughput efficiency.

The next scheduled packet for the particular connection has a corresponding size. The size of the packet is tested against the accumulated time slots that have been assigned to the connection. When the test reveals that sufficient resources (optionally, time slots) are available for the packet then the packet is scheduled for transmission in its entirety by the packetized proportional fair scheduler 42.

After each resource is allocated or packet is sent, the metrics are updated and the virtual allocation of fixed resources continues. Packets then continue to be sent as soon as the corresponding device has enough resources for the packet.

Thus packets are sent fairly and there is no discrimination against long packets beyond the straightforward need to obtain the transmission resource.

The fixed resources need not be time slots but may be frequency slots or any other fixed resources depending on the modulation schemes being used in the link.

Returning to FIG. 3 and transmitter/receiver unit 26 then transmits the packets, or in the case of the return link indicates to the assigned mobile stations that they have a slot for transmission. In the case of a return link the mobile stations may inform the base station of the number and size of packets they have for transmission so that packet scheduling can be carried out.

Packet transmission protocols have various systems for catering for packets that fail to arrive or arrive with errors. For example, the TCP/IP protocol provides for immediate retransmission of a packet that is missing or contains uncorrectable errors. However if all transmissions are scheduled in frames then immediate retransmission cannot be accommodated.

Thus the present embodiments may provide a retransmission estimator 28, which measures the quality of the connection to a given MS and provides an estimate of the expected retransmissions. The metric is then updated according to the estimate. That is to say the retransmission estimator continually estimates an expected number of packet retransmissions to a given terminal device, based on a current state of the connection to that terminal device. The estimate may be used by the variable packet transmission unit to modify the metric which in turn schedules the packets and retransmission packets in the frame at their actual arrival

In the above, the virtual proportional fair scheduler 40 carries out scheduling in a manner emulative of a proportional fair allocation of fixed transmission resources as used by the known art.

If fixed time slots were to be used directly then packets would have to be fragmented. Using such emulation coupled with a packetized allocation, each packet may be scheduled for sending without fragmentation. The emulation may ensure that packet transmission finishes substantially at, or preferably before, the time obtained in the simulation, or at least in the order obtained in the simulation 44.

The transmission link may be any link that uses packets and can use proportional fair scheduling, and is not restricted just to wireless examples with base stations and mobile stations as per the above examples. Examples include any TCP/IP link, including Internet, and LAN and WAN systems. Wireless examples include cellular links as well as WiMax links.

To better support packetized traffic, embodiments of a packet by packet scheduling scheme that emulates the proportional fair scheme are provided. Advantages of the present embodiments stem from the fact that the WiMAX system is based on packetized traffic (IP networks). Accordingly, packet by packet scheduling is more appropriate. As discussed above, fragmentation, meaning scheduling using units smaller than packet-sized, enables the scheduler to perform scheduling per a fixed resource quantum, based on time-frequency rectangles. However, fragmentation requires some additional fragmentation overheads, in particular a fragmentation sub-header—which tells the protocol how to reconstruct the packets from the fragments. In addition, transmission of many fragments of different connections requires additional map overheads to know which device gets which fragment. Thus each sub-burst is associated with its own MAP IE.

Packetized scheduling in accordance with the present embodiments may reduce these overheads.

Moreover, many types of data transmission have quality of service QoS requirements. For example, voice and video are required to play in real time, and QoS enhancements to the proportional fair scheme have been developed and published.

It is pointed out that packet transmission as described herein refers both to uplink and downlink packet transmission.

The present embodiments thus involve a virtual scheduler which assigns channel communication resources to the device which currently has a best metric. The scheduler assigns a resource to maximize i*, wherein:

$${i}^{*} = {arg}_{i} max \{ {P}_{i} \}$$

$$where$$

$${P}_{i} = \frac{{R}_{i}}{{[ {T}_{i} ]}^{α}}$$

Rᵢ is the data rate potentially achievable for the i-th mobile station based upon the reported C/I and the power available (MCSᵢ),
Tᵢ is the average fairness throughput of the i-th terminal before scheduling decision,
Tᵢ′ is the average fairness throughput of the i-th terminal after the scheduling decision, and
α is the fairness exponent factor.

Ti and Ti′ may be obtained as follows:

$${T}_{i} = \{ \begin{matrix}β {T}_{i} & if the HOL packet of the i \text{-} th MS was not scheduled \\ \begin{matrix}β {T}_{i} + \\ ( 1 - β ) {N}_{i}\end{matrix} & if the HOL packet of the i \text{-} th MS was scheduled\end{matrix} \\ and \\ {T}_{i}^{′} = β {T}_{i} + ( 1 - β ) {N}_{i}$$

The emulation may maximize

$${\sum }_{k = 1}^{K} log {T}_{k}$$

Where k is the packet index and Tₖ is the average fairness throughput of the ith mobile station up to slot k. The transmission link may be a WiMax link. There is thus provided a computationally sub-optimal but efficient solution to the problem of proportionally fair allocation of resources when the resources are used for transmission of packets which may be of variable size.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A scheduling method for transmission of packetized data over a transmission link between a base station and various terminal devices, said packetized data comprising a plurality of data packets, each packet being associated with one of said terminal devices, said packets being of variable length, the method comprising:
calculating for each terminal device a proportional fair allocation metric;
assigning a next available channel transmission resource to a device having a best metric; and
sending a next packet to a respective terminal device when respectively allocated and as yet unused channel transmission resources are sufficient to accommodate said next packet.

2. The method of claim 1, wherein said next available transmission resource is a fixed time slot.

3. The method of claim 2, wherein said sending a next packet to a respective terminal device when respectively allocated and as yet unused channel transmission resources are sufficient to accommodate said next packet, comprises sending said next packet when correspondingly allocated fixed time slots are sufficient for a respective length of said next packet.

4. The method of claim 1, wherein said proportional fair metric allocates said resources to said respective terminal devices in a manner emulative of a proportional fair allocation scheme for allocating fixed time slots between said devices.

5. The method of claim 4, wherein said sending to said resources comprises sending respective packets such that an end time for transmission of a given packet is at least as early as the transmission time of a last slot of the given packet had it been split between said fixed time slots of said proportional fair allocation scheme, said transmission time of said last slot being obtained by simulating said proportional fair allocation scheme.

6. The method of claim 4, wherein said proportional fair allocation metric takes account of a size of a respective packet.

7. The method of claim 4, wherein said assigning to a device having a best metric comprises assigning a resource to maximize i*, wherein:
$${i}^{*} = {arg}_{i} max \{ {P}_{i} \}$$
$$where$$
$${P}_{i} = \frac{{R}_{i}}{{[ {T}_{i} ]}^{α}}$$
Rᵢ is the data rate potentially achievable for the i-th mobile station based upon the reported C/I and the power available (MCSᵢ),
Tᵢ is the average fairness throughput of the i-th terminal before scheduling decision,
Tᵢ′ is the average fairness throughput of the i-th terminal after the scheduling decision, and
α is the fairness exponent factor.

8. The method of claim 7, wherein Ti and Ti′ are obtained as follows:
$${T}_{i} = \{ \begin{matrix}β {T}_{i} & if the HOL packet of the i \text{-} th MS was not scheduled \\ \begin{matrix}β {T}_{i} + \\ ( 1 - β ) {N}_{i}\end{matrix} & if the HOL packet of the i \text{-} th MS was scheduled\end{matrix} \\ and \\ {T}_{i}^{′} = β {T}_{i} + ( 1 - β ) {N}_{i}$$

9. The method of claim 4, wherein said emulation comprises maximizing
$${\sum }_{k = 1}^{K} log {T}_{k}$$
Where k is the packet index and Tₖ is the average fairness throughput of the ith mobile station up to slot k.

10. The method of claim 1, wherein said transmission link is a WiMax link.

11. Apparatus for allocating packets for transmission over a link between a base station and a plurality of terminal devices, respective packets being of variable length and link resources being shared between connections of said base station and respective terminal devices; the apparatus comprising:
a virtual fixed resource proportional fair scheduler operative to assign fixed link resources between respective connections based on a proportional fair metric; and
a packetized proportional fair scheduler configured to send a next packet over a given connection when said given connection has accrued sufficient of said fixed link resources to accommodate a size of said respective packet.

12. Apparatus according to claim 11, wherein said fixed link resources comprise fixed time slots.

13. Apparatus according to claim 11, comprising a buffer for storing packets until respective given connections have accrued said sufficient fixed link resources.

14. System comprising a base station and a plurality of terminal devices and an allocation unit for allocating packets for transmission over links between said base station and respective ones of said terminal devices, respective packets being of variable length and link resources being shared between said links; the allocation unit comprising:
a virtual fixed resource proportional fair scheduler operative to assign fixed link resources between respective links based on a proportional fair metric; and
a packetized proportional fair scheduler configured to send a next packet over a given link when said given link has accrued sufficient of said fixed link resources to accommodate a size of said respective packet.
